(19) United States
(12) Patent Application Publication
(10) Pub. No.: US 2024/0046112 A1
(43) Pub. Date: Feb. 8, 2024

(54) JOINTLY UPDATING AGENT CONTROL POLICIES USING ESTIMATED BEST RESPONSES TO CURRENT CONTROL POLICIES

(71) Applicant: DeepMind Technologies Limited, London (GB)

(72) Inventors: Luke Christopher Marris, London (GB); Paul Fernand Michel Muller, Le Perreux sur Marne (FR); Marc Lanctot, London (GB); Thore Kurt Hartwig Graepel, Cambridge (GB)

(21) Appl. No.: 18/275,881

(22) PCT Filed: Feb. 7, 2022
(86) PCT No.: PCT/EP2022/052905

§ 371 Date: Aug. 4, 2023

Related U.S. Application Data
(60) Provisional application No. 63/146,570, filed on Feb. 5, 2021.

(51) Int. Cl. G06N 3/092

(52) U.S. Cl. CPC G06N 3/092

(57) ABSTRACT

Methods, systems, and apparatus, including computer programs encoded on computer storage media, for generating control policies for controlling agents in an environment. One of the methods includes, at each of a plurality of iterations: obtaining a current joint control policy for a plurality of agents, the current joint control policy specifying a respective current control policy for each agent; and updating the current joint control policy, comprising, for each agent: generating a respective reward estimate for each of a plurality of alternate control policies that is an estimate of a reward received by the agent if the agent is controlled using the alternate control policy while the other agents are controlled using the respective current control policies; computing a best response for the agent from the respective reward estimates; and updating the respective current control policy for the agent using the best response for the agent.

### BACKGROUND

This specification relates to machine learning, and in example implementations to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that updates a joint control policy by which multiple agents interact with an environment. At each of multiple iterations, the system jointly updates, in parallel, the respective control policies of each of the agents. After the final iteration, the joint control policy can have been optimized for interacting with the environment according to some objective function. For example, the joint control policy can have converged to a Nash equilibrium (NE), a correlated equilibrium (CE), or a coarse correlated equilibrium (CCE).

The subject matter described in this specification can be implemented in particular embodiments so as to realize one or more of the following advantages.

Some existing systems sequentially update individual control policies of the agents in a multiplayer game. However, when there is dependence between the optimal control policy of different agents (e.g., in coordination or anti-coordination games), updating individual control policies sequentially can be slow to converge, or even converge to a sub-optimal solution. Using techniques described in this specification, a system can jointly update the control policy of each agent in a multiplayer game, allowing the system to efficiently identify optimal joint control policies, using less time and fewer resources than existing systems while having a higher likelihood of converging to an equilibrium, for example one which is a globally optimal solution.

Using techniques described in this specification, a system can efficiently generate joint control policies for n-player, general-sum games. Many existing systems generate control policies for agents in two-player, constant-sum games. Generally, identifying equilibria in n-player, general-sum games is a significantly more difficult challenge than identifying equilibria in two-player, constant-sum games.

For example, Nash equilibria are tractable and interchangeable in two-player, constant-sum games, but become intractable and non-interchangeable in n-player, general sum games. That is, unlike two-player, constant-sum games, there are no guarantees on the expected utility when each agent plays a different respective role in a state which is a Nash equilibrium; guarantees only hold when all agents play the same equilibrium. However, because agents cannot guarantee what strategies the other agents in the game choose to execute, the agents cannot optimize their own control policies independently. Thus, Nash equilibria lose their appeal as a prescriptive solution concept.

Using techniques described in this specification, a joint control policy can converge to a correlated equilibrium or a coarse correlated equilibrium. As described above, some existing systems update control policies of agents in an effort to converge to Nash equilibria. However, correlated equilibria can be preferable to Nash equilibria in many situations, for example, correlated equilibria are generally more flexible than Nash equilibria. The maximum sum of social welfare in correlated equilibria weakly exceeds that of any Nash equilibrium. In particular, correlated equilibria enable more intuitive solutions to anti-coordination games, i.e., games for which the selection of the same action by multiple players creates a negative cost for the multiple agents instead of a positive benefit.

One expression of a method disclosed by this document is a method performed by one or more computers for learning a respective control policy for each of a plurality of agents interacting with an environment, the method comprising, at each of a plurality of iterations:
obtaining data specifying a current joint control policy for the plurality of agents as of the iteration, the current joint control policy specifying a respective current control policy for each of the plurality of agents; and
updating the current joint control policy by updating each of the respective current control policies for each of the plurality of agents, comprising:
   for each agent:
      generating a respective reward estimate for each of a plurality of alternate control policies that is an estimate of a reward received by the agent if the agent is controlled using the alternate control policy while the other agents are controlled using the respective current control policies; and
      computing a best response for the agent from the respective reward estimates; and
   updating the respective current control policies for the agents using the best responses for the agents.

Note that the joint control policy may be in the form of a “mixed” joint control policy, which is a probability distribution over a set of one or more “pure” joint control policies, where each pure joint control policy comprises a respective (pure) control policy for each of the plurality of agents.

Accordingly, another method disclosed by this document is a method performed by one or more computers for learning a respective control policy for each of a plurality of agents interacting with an environment, the method comprising,
(i) at each of a plurality of iterations:
obtaining data specifying a probability distribution over a set of one or more joint control policies, each joint control policy specifying a respective control policy for each of the plurality of agents; and
updating the probability distribution by for each agent, and for each of the set of one or more joint control policies, by:
   generating a respective reward estimate for each of a plurality of alternate control policies that is an estimate of a reward received by the agent if the agent is controlled using the alternate control policy while the other agents are controlled using the respective control policies of the joint control policy;
   identifying one or more of the plurality of alternate control policies which has the highest respective reward estimates; and
   for each of the identified alternate control policies, adding to the set of one or more joint control polices, one or more additional joint control policies comprising the identified alternate control policy and control policies for the other agents already present in the set of joint control policies; and
defining a probability distribution over the set of one or more joint control policies; and
(ii) obtaining the respective control policy for each of the plurality of agents based on the probability distribution over the set of one or more joint control policies. For example, the respective control policy may be obtained from a joint control policy sampled from the probability distribution, or from a joint control policy determined to give a high (e.g. maximal) probability according to the probability distribution.

In both expressions of the invention, the reward estimate for each alternate control policy may be based on rewards obtained by controlling the agent to perform a task by acting on a real-world environment. For example, the agent may comprise an autonomous vehicle (e.g. a robot, or other electromechanical device) in the real world environment. The autonomous may be configured to move (e.g. by translation and/or reconfiguration) in the environment, e.g. to navigate through the environment. The reward represents how well the task is performed. The controlling may be performed by generating control data for the agent (e.g. autonomous vehicle) based on the alternate control policy.

The control data for the agent (e.g. autonomous vehicle) may be obtained based on the alternate control policy and sensor data obtained from a sensor arranged to sense the real world environment. That is, the sensor data, which characterizes a state of the environment, may be used as an input to the alternate control policy to determine an action, and control data may be generated to control the agent to perform the action. For example, the control data may transmitted to one or more actuators of the agent, to control the one or more actuators.

Once the respective control policy for each of the plurality of agents has been learned, a plurality of agents (e.g. comprising respective robots or autonomous vehicles) can be controlled to perform the task in the real world environment, by generating respective control data for each of the agents based on the respective control policy and sensor data obtained from a sensor arranged to sense the real world environment; and causing each of the agents to implement the respective control data.

Note that in principle the learning of the respective control policy for each of the plurality of agents could be performed using simulated agents interacting with a simulated environment to generate the reward estimates, instead of real agents interacting with a real-world environment. The learned control policies could then be used to control (real) agents (e.g. electromechanical agents) interacting with the real world environment. This possibility is advantageous because the cost of learning the control policies for the agents by simulation is liable to be much less than doing it in the real world.

Using techniques described in this specification, a system can generate control policies for a set of agents interacting in an environment (e.g., a set of physical agents such as robots or autonomous vehicles interacting in a physical environment) more quickly and with less computational and memory resources than some other existing systems. For example, the system can generate the control policies in fewer iterations of the system, where the system updates a current set of control policies at each iteration; as a particular example, the system can generate the control policies in 25%, 40%, 50%, 75%, or 90% fewer iterations than some existing techniques. Furthermore, the control policies learned by the system can achieve a higher measure of global value for the agents relative to control policies learned using some existing techniques, e.g., achieving a 25%, 100%, 500%, or 800% higher measure of global value for the agents operating in the environment.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system that includes a joint control policy generation system.

FIG. 2 is a diagram of an example joint control policy generation system.

FIG. 3 is a flow diagram of an example process for generating a joint control policy for multiple agents interacting with an environment.

FIG. 4 is a flow diagram of an example process for using a Gini impurity measure to generate a mixed joint control policy.

Like reference numbers and designations in the various drawings indicate like elements.

### DETAILED DESCRIPTION

This specification describes a system implemented as computer programs on one or more computers in one or more locations that is configured to jointly generate respective control policies for each of multiple agents interacting with an environment.

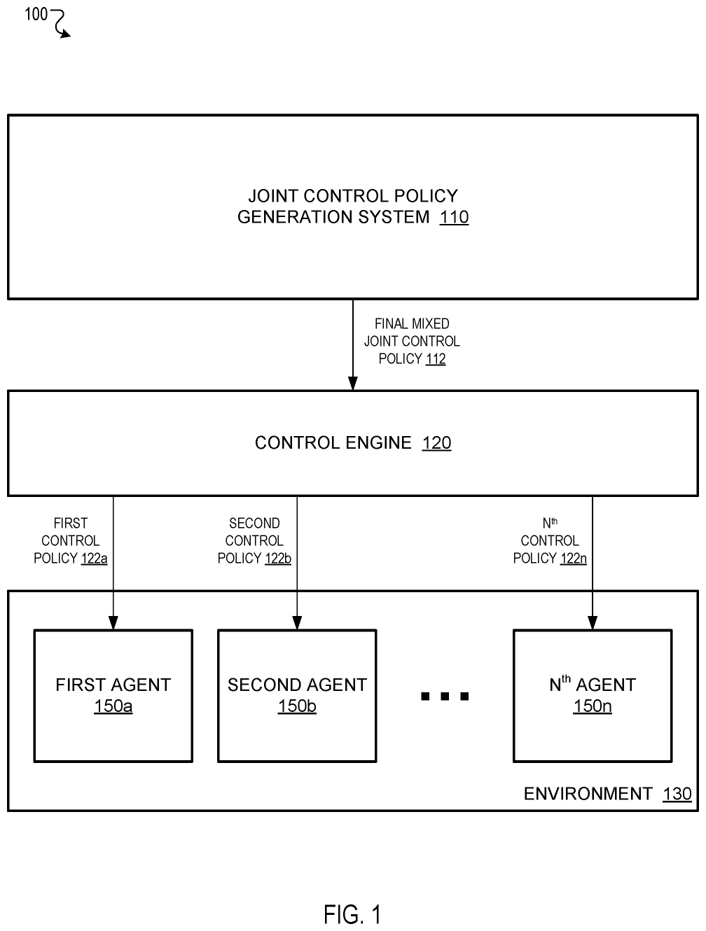

FIG. 1 is a diagram of an example system 100 that includes a joint control policy generation system 110. The system 100 is an example of a system implemented as computer programs on one or more computers in one or more locations, in which the systems, components, and techniques described below can be implemented.

The joint control policy generation system 110 is configured to generate a mixed joint control policy 112 to be executed by n agents 150a-n interacting with an environment 130, where n>1.

In this specification, a control policy for an agent is a set of one or more rules by which the agent selects actions to interact with an environment. For example, referring to FIG. 1, each agent 150a-n can select an action for interacting with the environment 130 according to the set of rules defined by a corresponding control policy 122a-n.

In this specification, a joint control policy is a set of control policies that includes a respective control policy for each of multiple agents in an environment. For example, a joint control policy for the agents 150a-n might include the n respective control policies 122a-n.

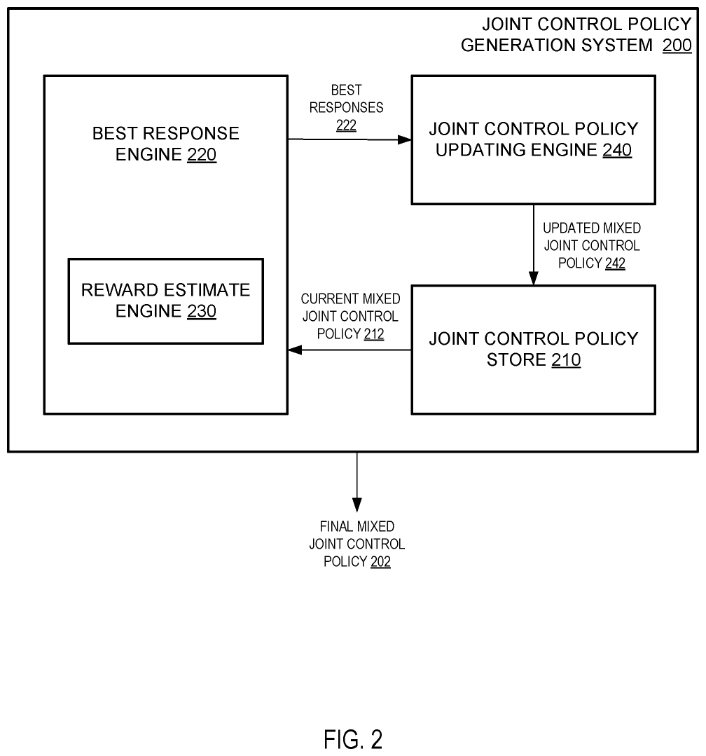

As described in more detail below with reference to FIG. 2, the joint control policy generation system 110 iteratively generates new control policies for the agents 150a-n, and, at each iteration, generates a new mixed joint control policy that defines a distribution over the pure joint control policies determined from the control policies that have been generated up to the current iteration. In this specification, a joint control policy that defines a distribution over other joint control policies is called a “mixed” joint control policy. The distribution over joint control policies, as defined by the mixed joint control policy, can also be referred to as a joint distribution over the control policies of each of the agents in the environment. That is, given a set of control policies for each agent, the mixed joint control policy defines a joint distribution over the respective control policies for the agents. In other words, where this specification refers to a mixed joint control policy for a set of agents, the specification could equivalently have referred to a joint distribution over respective control policies for the agents.

In this specification, a joint control policy that does not define a distribution over other joint control policies but rather identifies a single control policy for each respective agent is called a “pure” joint control policy. In other words, a mixed joint control policy defines a distribution over pure joint control policies.

The goal of the joint control policy generation system 110 is to generate, after the final iteration of the joint control policy generation system 110, a final mixed joint control policy 112 to be executed by the agents 150a-n. That is, the joint control policy generation system 110 only outputs the final mixed joint control policy 112 after the final iteration of the joint control policy generation system 110.

Given the final mixed joint control policy 112, at each of one or more time points in the environment 130, a control engine 120 that is in communication with the agents 150a-n can sample a pure joint control policy for the agents 150a-n from the distribution over pure joint control policies defined by the final mixed joint control policy 112. The sampled pure joint control policy includes a respective control policy 122a-n for each agent 150a-n in the environment 130. The control engine 120 sends data representing the respective control policy 122a-n to each agent 150a-n, and each agent 150a-n can then select an action to take using the corresponding control policy 122a-n.

In some implementations, the control engine 120 samples a single pure joint control policy from the final mixed joint control policy 112 before the agents 150a-n interact with the environment 130, and the agents use the respective control policies 122an from the sampled pure joint control policy throughout their interaction with the environment 130, i.e., where each agent 150a-n uses the respective control policy 122a-n to select actions throughout their interaction with the environment.

In some other implementations, at multiple different time points during the interaction between the agents 150a-n and the environment 130, the control engine 120 samples a new pure joint control policy from the final mixed joint control policy 112 and communicates the corresponding new control policies 122a-n from the new sampled pure joint control policy to the agents 150a-n. Thus, the agents 150a-n can use different control policies 122a-n for interacting with the environment 130 at different time points, where all control policies 122a-n for all time points have been determined from the same final mixed joint control policy 112. As a particular example, if the agents 150a-n take actions in the environment 130 synchronously, the control engine 120 can sample a new pure joint control policy from the final mixed joint control policy 112 before or after each synchronous set of actions is taken; that is, each control policy 122a-n can be used by the respective agent 150a-n to select a single action before being replaced by the next control policy 122a-n received from the control engine 120.

In some implementations, one or more of the control policies 122a-n depends on a current state of the environment 130. For example, an agent 150a-n can obtain an observation of the environment 130 and process the observation according to the corresponding control policy 122a-n to select an action. In some other implementations, the control policies 122a-n do not depend on the current state of the environment 130; that is, for each agent 150a-n, the agent 150a-n can select actions according to the same set of rules defined by the corresponding control policy 122a-n regardless of the current state of the environment, e.g., by sampling from a predetermined distribution across possible actions by the agent 150a-n.

In some implementations, the respective control policy 122a-n of each agent 150an is exactly defined, e.g., using a distribution across possible actions for the agent 150a-n or using a decision tree.

In some other implementations, the respective control policy 122a-n for one or more of the agents 150a-n is approximated, e.g., using a machine learning model that is configured to generate a model output identifying an action for the agent 150a-n to take. As a particular example, the control policy 122a-n for a particular agent 150a-n can be defined by a neural network that is configured to process a network input, e.g., a network input that identifies a current state of the environment 130, and to generate a network output that identifies an action for the particular agent 150a-n to take. For instance, the network output can specify a score distribution across possible actions for the particular agent 150a-n, and the particular agent 150a-n can be configured to execute the action with the highest score in the score distribution, or sample an action according to the score distribution and execute the sampled action.

In some such implementations, for each machine learning model defined by a respective control policy 122a-n that can be sampled for the particular agent 150a-n from the final mixed control policy 112, the particular agent 150a-n stores data representing the machine learning model (e.g., by storing data representing the trained model parameters of the machine learning model); then, after sampling a control policy 122a-n that defines a particular machine learning model, the control engine 120 sends data identifying the particular machine learning model to the particular agent 150a-n. In some other such implementations, the control engine 120 sends the data representing the particular machine learning model (e.g., the data representing the trained model parameters of the particular machine learning model) directly to the particular agent 150a-n.

Examples of environments 130 and agents 150a-n that can execute control policies 122a-n generated by the joint control policy generation system 110 are discussed below.

The joint control policy generation system 110 can be configured to generate control policies 122a-n for any appropriate type of agent 150a-n interacting in a multi-agent system. Such systems are common in the real world and may include, for example, systems that include multiple autonomous vehicles such as robots that interact whilst performing a task (e.g. warehouse robots), factory or plant automation systems, and computer systems. In such cases, the agents may be the robots, items of equipment in the factory or plant, or software agents in a computer system that, e.g., control the allocation of tasks to items of hardware or the routing of data on a communications network.

In some applications each agent of the group of agents comprises a robot or autonomous or semi-autonomous land or air or sea vehicle. The agents may be configured to navigate a path through a physical environment from a start point to an end point. For example the start point may be a present location of the agent; the end point may be a destination of the agent. The rewards of the agents may be dependent on an estimated time or distance for the first or each agent to physically move from the start point to the end point. For example, the objective of an agent may be to minimize an expected delay or maximize an expected reward or return (cumulative reward) dependent upon speed of movement of the agent; or to minimize an expected length of journey.

The actions performed by an agent may include navigation actions to select between different routes to the same end point. For example the actions may include steering or other direction control actions for the agent.

As previously noted, the rewards/returns may be dependent upon a time or distance between nodes of a route and/or between the start and end points. The routes may be defined, e.g., by roads, or in the case of a warehouse by gaps between stored goods, or the routes may be in free space, e.g., for drone agents. The agents may comprise robots or vehicles performing a task such as warehouse, logistics, or factory automation, e.g. collecting, placing, or moving stored goods or goods or parts of goods during their manufacture; or the task performed by the agents may comprise package delivery control.

In some applications an agent may be configured to control traffic signals, e.g. at junctions to control the traffic flow of pedestrian traffic and/or human-controlled vehicles. The implementation details of such systems may be as previously described for robots and autonomous vehicles.

In general the agents may receive observations of the environment that may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agents. The observations may be defined in 1, 2, 3, or more dimensions, and may be absolute and/or relative observations. For example, in the case of a robot the observations may include data characterizing the current state of the robot, e.g., one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control inputs to control the robot, e.g., torques for the joints of the robot or higher-level control commands; or to control the autonomous or semi-autonomous land or air or sea vehicle, e.g., torques to the control surface or other control elements of the vehicle or higher-level control commands; or e.g. motor control data. In other words, the actions can include, for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example, in the case of an autonomous or semi-autonomous land or air or sea vehicle the actions may include actions to control navigation, e.g., steering, and movement, e.g., braking and/or acceleration of the vehicle.

In some further related applications the technique is applied to simulations of such systems. For example such a simulation be used to design a route network such as a road network or warehouse or factory layout.

For example, the simulated environment may be a simulation of a robot or vehicle agent and the system may be trained on the simulation. For example, the simulated environment may be a motion simulation environment, e.g., a driving simulation or a flight simulation, and the agent is a simulated vehicle navigating through the motion simulation. In these implementations, the actions may be control inputs to control the simulated user or simulated vehicle. A simulated environment can be useful for training a system before using the system in the real world. In another example, the simulated environment may be a video game and the agent may be a simulated user playing the video game. Generally in the case of a simulated environment the observations may include simulated versions of one or more of the previously described observations or types of observations and the actions may include simulated versions of one or more of the previously described actions or types of actions.

In the case of an electronic agent the observations may include data from one or more sensors monitoring part of a plant or service facility such as current, voltage, power, temperature and other sensors and/or electronic signals representing the functioning of electronic and/or mechanical items of equipment. In some applications the agent may control actions in a real-world environment including items of equipment, for example in a facility such as: a data center, server farm, or grid mains power or water distribution system, or in a manufacturing plant or service facility. The observations may then relate to operation of the plant or facility. For example, additionally or alternatively to those described previously, the observations may include observations of power or water usage by equipment, or observations of power generation or distribution control, or observations of usage of a resource or of waste production. The agent may control actions in the environment to increase efficiency, for example by reducing resource usage, and/or reduce the environmental impact of operations in the environment, for example by reducing waste. For example, the agent may control electrical or other power consumption, or water use, in the facility and/or a temperature of the facility and/or items of equipment within the facility. The actions may include actions controlling or imposing operating conditions on items of equipment of the plant/facility, and/or actions that result in changes to settings in the operation of the plant/facility, e.g., to adjust or turn on/off components of the plant/facility.

In some further applications, the environment is a real-world environment and the agent manages distribution of tasks across computing resources, e.g., on a mobile device and/or in a data center. In these implementations, the actions may include assigning tasks to particular computing resources.

In another application the real-world environment is a data packet communications network environment, and each agent of the group of agents comprises a router that is configured to route packets of data over the communications network. The rewards of the agents may then be dependent on a routing metric for a path from the router to a next or further node in the data packet communications network, e.g., an estimated time for a group of one or more routed data packets to travel from the router to a next or further node in the data packet communications network. The observations may comprise, e.g., observations of a routing table which includes the routing metrics. A route metric may comprise a metric of one or more of path length, bandwidth, load, hop count, path cost, delay, maximum transmission unit (MTU), and reliability.

In another application the real-world environment is an electrical power distribution environment. As power grids become more decentralized, for example because of the addition multiple smaller capacity, potentially intermittent renewable power generators, the additional interconnections amongst the power generators and consumers can destabilize the grid and a significant proportion of links can be subject to Braess's paradox where adding capacity can cause overload of a link, e.g., particularly because of phase differences between connected points.

In such an environment each agent may be configured to control routing of electrical power from a node associated with the agent to one or more other nodes over one or more power distribution links, e.g., in a “smart grid”. The rewards of the agents may then be dependent on one or both of a loss and a frequency or phase mismatch over the one or more power distribution links. The observations may comprise, e.g., observations of routing metrics such as capacity, resistance, impedance, loss, frequency or phase associated with one or more connections between nodes of a power grid. The actions may comprise control actions to control the routing of electrical power between the nodes.

The agents may further comprise static or mobile software agents, i.e., computer programs configured to operate autonomously and/or with other software agents or people to perform a task. For example, the environment may be an integrated circuit routing environment and each agent of the group of agents may be configured to perform a routing task for routing interconnection lines of an integrated circuit such as an ASIC. The rewards of the agents may be dependent on one or more routing metrics such as an interconnect resistance, capacitance, impedance, loss, speed or propagation delay, physical line parameters such as width, thickness or geometry, and design rules. The objectives may include one or more objectives relating to a global property of the routed circuitry, e.g., component density, operating speed, power consumption, material usage, or a cooling requirement. The actions may comprise component placing actions, e.g., to define a component position or orientation and/or interconnect routing actions, e.g., interconnect selection and/or placement actions.

FIG. 2 is a diagram of an example joint control policy generation system 200. The joint control policy generation system 200 is an example of a system implemented as computer programs on one or more computers in one or more locations, in which the systems, components, and techniques described below can be implemented.

The joint control policy generation system 200 is configured to generate a mixed joint control policy 202 to be executed by n agents interacting with an environment, where n>1, and may be greater than two. For example, the joint control policy generation system 200 can be configured to generate a final mixed joint control policy 202 for the agents 150a-n in the environment 130 described above with reference to FIG. 1.

In particular, the joint control policy generation system 200 is configured to iteratively update a current mixed joint control policy 212 over multiple iterations. By updating the current mixed joint control policy 212 at each iteration, the joint control policy generation system 200 implicitly updates the respective control policy by which each agent is to interact with the environment, as the respective control policy for each agent is defined by the current mixed joint control policy 212, i.e., by the joint distribution over the control policies for the agents defined by the current mixed joint control policy 212. The joint control policy generation system 200 includes a joint control policy store 210, a best response engine 220, and a joint control policy updating engine 240.

For each agent p of the n agents, the set of all control policies available to the agent p is given by Πₚ*. The set of all pure joint control policies available to the n agents is given by Π*=⊗ₚΠₚ*. where ⊗ₚ is an outer product across elements of the sets Πₚ* for each agent p.

As described in more detail below, at each iteration t of the execution of the joint control policy generation system 200, the joint control policy generation system 200 generates new control policies (called best responses 222) for the n agents. At each iteration t, and for each agent p of the n agents, the set of all control policies generated by the joint control policy generation system 200 for the agent p up to iteration t is given by Πₚ^{t}. Thus, the set of all pure joint control policies evaluated by the joint control policy generation system 200 up to iteration t (i.e., the set of all pure joint control policies determined from the individual control policies generated up to iteration t) is given by Π^{t}=⊗ₚΠₚ^{t}. Thus, at each iteration the set Π^{t} of joint control policies, each of which specifies a respective control policy for each of the agents, is supplemented by adding to it new joint control policies which comprise the new control policies for a corresponding one of the agents and control policies for other agents which were already present in the set of control policies.

At each iteration t, the current mixed joint control policy 212 is defined by (i) the set Π^{t} of all pure joint control policies evaluated by the joint control policy generation system 200 up to iteration t and (ii) a distribution σₜ over Π^{t} that defines, for each pure joint control policy π∈Π^{t}, a probability σₜ(π) that the pure joint control policy π will be executed by the agents according to the current mixed joint control policy 212.

The joint control policy store 210 is configured to maintain, at each iteration of the execution of the joint control policy generation system 200, data representing the current mixed joint control policy 212, i.e., to maintain, at each iteration t, the set Π^{t} and the distribution σₜ.

Before the first iteration of the execution of the joint control policy generation system 200, the joint control policy generation system 200 can define one or more initial control policy πₚ⁰ for each agent p. That is, if the joint control policy generation system 200 selects B initial control policies for the agent p, then Πₚ⁰={πₚ^{0,i}∀i∈[1, . . . , B]}. Each initial control policy πₚ^{0,i} for each agent p can be any appropriate control policy for the agent. For example, the joint control policy generation system 200 can randomly sample (e.g., uniformly sample) the initial control policies πₚ^{0,i}˜Πₚ*. As a particular example, the joint control policy generation system 200 can generate a set Πₚ⁰ of initial control policies for each agent p that includes a diverse range of control policies πₚ^{0,i}, so that the final mixed joint control policy 202 generated by the joint control policy generation system 200 is not dependent on the initialization of Πₚ^{0,i}.

Thus, before the first iteration of the execution of the joint control policy generation system 200, the joint control policy generation system 200 can initialize the current mixed joint control policy 212 Π⁰=⊗ₚΠₚ⁰. In implementations in which the joint control policy generation system 200 generates only a single initial control policy πₚ⁰ for each agent p, the set Π⁰ includes only a single pure joint control policy in which each agent p executes its initial control policy πₚ⁰, where σ₀(π₁⁰, . . . , πₙ⁰)=1, i.e., the probability that the agents play the single pure joint control policy in Π⁰ is 1.

At each iteration of the execution of the joint control policy generation system 200, the best response engine 220 is configured to determine (or estimate, as described in more detail below), for each agent, a respective best response 222 to the current mixed joint control policy 212.

In this specification, a “best response” for an agent in a multi-agent setting is a control policy that, among all possible control policies for the agent and given a predetermined joint control policy (i.e., a pure or mixed joint control policy), would provide the highest expected reward to the agent if (i) the agent executes the best response and (ii) the other agents in the multi-agent setting take actions according to the predetermined joint control policy.

At each iteration t, the best response engine 220 obtains the current mixed joint control policy 212 from the joint control policy store 210. The best response engine 220 can then determine, for each agent, the best response 222 for the agent given the current mixed joint control policy 212. The best response for each agent p at iteration t is given by BRₚ^{t}.

For example, to determine the best response 222 for a particular agent, the best response engine 220 can determine a control policy for the particular agent that maximizes the weighted sum of expected rewards for the particular agent across all pure joint control policies in the current mixed joint control policy 212, where each pure joint control policy π∈Π^{t} is weighted by its corresponding probability σₜ(π).

That is, for each agent p, the best response engine 220 can compute or estimate:

$${BR}_{p}^{t} ∈ {arg max}_{{π}_{p}^{′} ∈ {\prod }_{p}^{*}} {\sum }_{π ∈ {\prod }^{t}} {σ}_{t} ( π ) {R}_{p} ( {π}_{p}^{′} , {π}_{- p} )$$

where π₋ₚ represents the respective control policy of each other agent of the n−1 other agents under pure joint control policy π, and Rₚ(πₚ′, π₋ₚ) is the expected reward for the agent p if the agent p executes πₚ′ and the other agents execute π₋ₚ. The control policies πₚ′∈Πₚ*; evaluated during the computation of the argmax are sometimes called “alternate control policies” for the agent p. They may be generated in any way, e.g. randomly and/or by perturbations to control policies for the agent p which are already part of π^{t}.

The above formulation of the best response BRₚ^{t} exploits the joint distribution σₜ to maximize the expected reward for agent p with the policy preferences of agent p marginalized out. That is, the above formulation of the best response BRₚ^{t} does not depend on any given πₚ∈Πₚ^{t}, i.e., on any given control policy for the agent p that has been evaluated so far. The above formulation for the best response BRₚ^{t} is sometimes called the coarse correlated equilibrium (CCE) best response operator.

The best response engine 220 includes a reward estimate engine 230 that is configured to compute or estimate the expected reward Rₚ(πₚ,π₋ₚ) for agent p if the agent p executes control policy πₚ and the n−1 other agent execute π₋ₚ. In some implementations, the reward estimate engine 230 determines the expected reward Rₚ for agent p exactly, e.g., using a set of rules of the environment. In some other implementations, the reward estimate engine 230 generates an estimate of the expected reward Rₚ for agent p, e.g., by performing one or more simulations of the environment if the agents execute the corresponding control policies.

To compute the argmax defined above, in some implementations, the best response engine 220 exactly traverses a decision tree that defines interactions in the environment. In some other implementations, the best response engine 220 can execute a machine learning model to estimate the argmax, e.g., by training a reinforcement learning model that controls the agent p interacting with the environment given that each other agent is executing the corresponding control policy. That is, the trained reinforcement learning model (e.g., as parameterized by a trained neural network) represents as estimation of the best response 222.

As another example, to determine the best response 222 for a particular agent 150a-n, the best response engine 220 can determine a respective control policy for the particular agent corresponding to each πₚ∈Πₚ^{t}, i.e., corresponding to each control policy for the agent p that has been evaluated by the joint control policy generation system 200. In other words, the best response engine 220 can compute a best response for the agent p for each control policy πₚ that has a non-zero likelihood under the current mixed joint control policy 212, i.e., the mixed joint control policy determined at the previous iteration.

The best response 222 corresponding to a control policy πₚ represents a different control policy that the agent p would prefer over the control policy πₚ. That is, if the agent p was given (e.g., by the control engine 120 described above with reference to FIG. 1) a recommendation to execute πₚ, then the best response 222 corresponding to πₚ represents the control policy that the agent p would defect to executing instead of πₚ. The best response 222 to πₚ assumes that no other agent defects, i.e., assumes that each other agent executes control policies according to the current mixed joint control policy 212 conditioned on the agent p executing πₚ.

That is, for each agent p, the best response engine 220 can compute or estimate:

$${BR}_{p}^{t} ( {π}_{p} ) ∈ {arg max}_{{π}_{p}^{′} ∈ {\prod }_{p}^{*}} {\sum }_{{π}_{- p} ∈ {\prod }_{- p}^{t}} {σ}_{t} ( {π}_{- p} \vert {π}_{p} ) {R}_{p} ( {π}_{p}^{′} , {π}_{- p} )$$

where Π₋ₚ^{t}=⊗_{q≠p}Π_{q}^{t}. The above formulation for the best response BRₚ^{t} is sometimes called the correlated equilibrium (CE) best response operator. The control policies πₚ′∈Πₚ* evaluated during the computation of the argmax are sometimes called “alternate control policies” for the agent p. Again, they may be generated in any way, e.g. randomly and/or by perturbations to control policies for the agent p which are already part of Πₚ^{t}.

The term σₜ(π₋ₚ|πₚ) in the best response formulation above can equivalently be written as:

$${σ}_{t} ( {π}_{- p} \vert {π}_{p} ) = {\tilde{σ}}_{t} ( π , {υ}_{p} ) = P ( π \vert {π}_{p} = {υ}_{p} ) = \frac{{σ}_{t} ( π )}{{\sum }_{{π}^{′} ∈ {Π}^{t} , {π}_{p}^{′} = {υ}_{p}} {σ}_{t} ( {π}^{′} )}$$

Thus, in some implementations, the best response engine 220 can be configured, at each iteration, to generate multiple different best responses 222 for each agent.

As described above, to compute the argmax defined above, in some implementations, the best response engine 220 exactly traverses a decision tree that defines interactions in the environment. In some other implementations, the best response engine 220 can execute a machine learning model to estimate the argmax, e.g., by training a reinforcement learning model that controls the agent p interacting with the environment given that each other agent is executing the corresponding control policy.

In some implementations, the best response engine 220 can determine the one or more best responses 222 for each agent in parallel across the agents, further improving the efficiency of the joint control policy generation system 200.

After determining the one or more best responses 222 for each agent given the current mixed joint control policy 212, the best response engine 220 provides the best responses 222 to the joint control policy updating engine 240. The joint control policy updating engine 240 is configured to generate an updated mixed joint control policy 242 by combining (i) the current mixed joint control policy 212 and (ii) the respective best responses 222 for each agent.

In particular, the joint control policy updating engine 240 generates a new set Πₚ^{t+1} for each agent p by appending the one or more best responses 222 for the agent p to the previous set Πₚ^{t}, i.e., Πₚ^{t+1}=Πₚ^{t}∪{BRₚ^{t}}. The joint control policy updating engine 240 can then generate a new set Π^{t+1}=Πₚ^{t+1}.

After determining Π^{t+1}, the joint control policy updating engine 240 can determine a new distribution σₜ₊₁ over Π^{t+1}. The distribution σₜ₊₁ over the set Π^{t+} represents an implicit definition of a respective control policy by which each agent is to interact with the environment, e.g., after the respective control policies are sampled from the distribution σₜ₊₁.

The joint control policy generation system 200 can use any appropriate technique to generate the new distribution σₜ₊₁. Such techniques are sometimes called “meta-solvers.” For example, the joint control policy generation system 200 can use a meta-solver that is configured to select a distribution σₜ₊₁ that is a correlated equilibrium (CE) or a coarse correlated equilibrium (CCE). To name a few particular examples, the joint control policy generation system 200 can use a uniform meta-solver that places an equal probability mass over each pure joint control policy π∈^{t+1}; a Nash Equilibrium (NE) meta-solver; a projected replicator dynamics (PRD) meta-solver that is an evolutionary technique for approximating NE; an α-rank meta-solver that leverages a stationary distribution of a Markov chain defined using the set Π^{t+1}; a maximum welfare CCE or maximum welfare CE meta-solver that uses a linear formulation that maximizes the sum of rewards for all agents; a random vertex CCE or random vertex CE meta-solver that uses a linear formulation that randomly samples vertexes on a polytope defined by the CCE/CE; a maximum entropy CCE or maximum entropy CE meta-solver that uses a nonlinear convex formulation that maximizes Shannon entropy of the resulting distribution σₜ₊₁; a random Dirichlet meta-solver that samples a distribution randomly from a Dirichlet distribution with α=1; or a random joint meta-solver that places all probability mass on a single pure joint control policy sampled from the set Π^{t+1}.

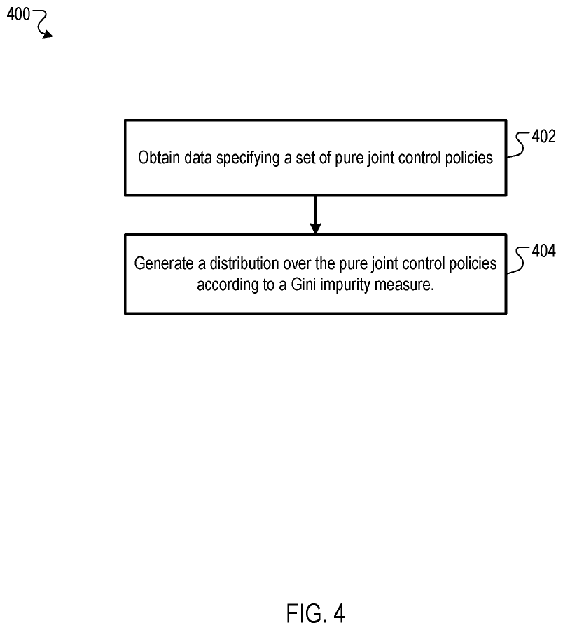

As another example, the joint control policy generation system 200 can use a meta-solver that is configured to select a distribution σₜ₊₁ that is a correlated equilibrium (CE) or a coarse correlated equilibrium (CCE) using a Gini impurity measure. Example techniques for using a Gini impurity measure to generate a distribution over pure joint control policies are discussed below with reference to FIG. 4.

The joint control policy generation system 200 can repeat the process described above for any appropriate number of iterations. For example, the joint control policy generation system 200 can execute a predetermined number of iterations. As another example, the joint control policy generation system 200 can execute iterations for a predetermined amount of time.

As another example, after each iteration, the joint control policy generation system 200 can determine a measure of utility of the updated mixed joint control policy 242. The joint control policy generation system 200 can determine to stop executing when the difference between (i) the measure of utility computed after the previous iteration and (ii) the measure of utility computed after the current iteration is below a predetermined threshold. For example, the measure of utility can represent a global or cumulative expected reward across the agents. As another example, the joint control policy generation system 200 can determine a respective different measure of utility corresponding to each agent (e.g., representing the expected reward for the agent under the current mixed joint control policy 242) and determine to stop executing when the respective measures of utility for each agent stops improving (i.e., the difference between (i) the measure of utility for the agent determined at the previous iteration and (ei) the measure of utility for the agent determined at the current iteration falls below a predetermined threshold).

As another example, the joint control policy generation system 200 can determine to stop executing when the measure of utility exceeds a predetermined threshold, or when the respective measures of utility corresponding to each agent exceeds a predetermined threshold.

As described above with reference to FIG. 1, after generating the final mixed joint control policy 102 for the agents, the joint control policy generation system 200 can provide data representing the final mixed joint control policy 202 to a control engine that is in communication with each of the agents in the environment. At one or more time points during the interaction between the agents and the environment, the control engine can sample a pure joint control policy from the final mixed joint control policy 202, where the sampled pure joint control policy includes a respective control policy for each agent. The agents can then execute the respective control policies, i.e., by using the control policies to select actions for interacting with the environment.

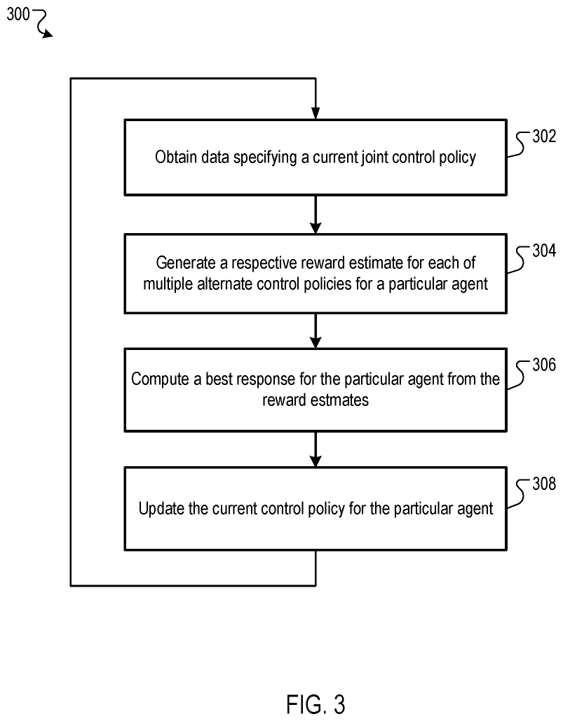

FIG. 3 is a flow diagram of an example process 300 for generating a joint control policy for multiple agents interacting with an environment. For convenience, the process 300 will be described as being performed by a system of one or more computers located in one or more locations. For example, a joint control policy generation system, e.g., the joint control policy generation system 110 described above with reference to FIG. 1, or the joint control policy generation system 200 described above with reference to FIG. 2, appropriately programmed in accordance with this specification, can perform the process 300.

The system can repeat the process 300 at each of multiple iterations to generate the final joint control policy for the multiple agents, which is a mixed joint control policy that defines a distribution over a set of multiple pure joint control policies.

The system obtains data specifying a current joint control policy for the multiple agents as of the current iteration (step 302).

The current joint control policy specifies a respective current control policy for each of the multiple agents. In particular, the current joint control policy is a mixed joint control policy that includes a set of multiple pure joint control policies, each of which include a respective control policy for each of the agents. The distribution over the set of pure joint control policies, as defined by the current joint control policy, defines the respective current control policy for each of the multiple agents.

The system can repeat the steps 304, 306, and 308 for each of the multiple agents to update the current joint control policy. In some implementations, the system executes the steps 304, 306, and 308 for each of the agents in parallel across the agents. The below description refers to the system executing the steps 304, 306, and 308 for a particular agent.

The system generates a respective reward estimate for each of multiple alternate control policies for the particular agent (step 304). The reward estimate for an alternate control policy is an estimate of a reward received by the agent if the agent is controlled using the alternate control policy while the other agents are controlled using the respective current control policies as defined by the current joint control policy. That is, the reward estimate identified the reward for the particular agent if the particular agent defects to execute the alternate control policy while none of the other agents defect.

For example, the system can generate the reward estimates for the alternate control policies as described above with reference to FIG. 2, e.g., according to one of the argmax definitions above.

The system computes a best response for the particular agent from the respective reward estimates (step 306). The best response for the particular agent represents the control policy that maximizes the reward for the particular agent if the other agents execute the current joint control policy.

The system updates the current control policy for the particular agent using the best response for the agent (step 308). In particular, the system can incorporate the best response for the particular agent into the set of pure joint control policies (i.e., by defining pure joint control policies wherein the particular agent executes the best response as described above with reference to FIG. 2), and update the distribution over the set of pure joint control policies. The updated distribution thus defines the updated control policy for the particular agent.

FIG. 4 is a flow diagram of an example process 400 for using a Gini impurity measure to generate a mixed joint control policy. For convenience, the process 400 will be described as being performed by a system of one or more computers located in one or more locations. For example, a joint control policy generation system, e.g., the joint control policy generation system 110 described above with reference to FIG. 1, or the joint control policy generation system 200 described above with reference to FIG. 2, appropriately programmed in accordance with this specification, can perform the process 400.

The mixed joint control policy can be used to control a set of multiple agents interacting with an environment, as described above with reference to FIG. 1. The mixed joint control policy defines (i) a set of pure joint control policies Π^{t+1} and (ii) a distribution σₜ₊₁ over the set of pure joint control policies, where t identifies a current iteration of the system, e.g., the current iteration of the joint control policy generation system. That is, the system can perform the process 400 at each of multiple iterations to iteratively update the mixed joint control policy.

The system obtains data specifying the set Π^{t+1} of pure joint control policies (step 402).

The system generates the distribution σₜ₊₁ over the pure joint control policies according to a Gini impurity measure (step 404). The distribution σₜ₊₁ can be a correlated equilibrium (CE) or a coarse correlated equilibrium (CCE)

The Gini impurity of a distribution a can be defined as 1−σ^{T}σ. The system can maximize the Gini impurity (or an equivalent objective such as −½σ^{T}σ) of the distribution over Π^{t+1} to determine σ*=σₜ₊₁.

For example, the system can compute the following quadratic program with linear constraints:

max−½σ^{T}σ s.t.

Aₚσ≤ϵ∀p

σ≥0, e^{T}σ=1

where for each agent p, Aₚ is a matrix representing a payoff (i.e., reward) gain for the agent p if the agent p switches its control policy, e is a vector of ones, and ϵ is a hyperparameter of the system that represents error toleration.

The matrix Aₚ can have shape [|Πₚ^{t+1}|·(|Πₚ^{t+1}−1|), |Π^{t+1}|], i.e., where each row corresponds to a pair of different control policies for the agent p (with the minus-one term reflecting the fact that a control policy does not need to be compared with itself), and each column corresponds to a joint control policy.

The matrix Aₚ can be sparse, e.g., only

$$\frac{1}{\vert {Π}_{p}^{t + 1} \vert}$$

of the elements can be non-zero, corresponding to the elements in each row of the matrix Aₚ for which (i) the control policy for the agent p defined by the joint control policy corresponding to the column of the element matches (ii) the initial control policy for the agent p corresponding to the row of the element. Each such non-zero element can be defined as:

Aₚ(πₚ′,πₚ,π₋ₚ)=R(πₚ′,π₋ₚ)−R(πₚ,π₋ₚ)

where πₚ is the initial control policy for agent p corresponding to the row of the element, πₚ f is the control policy to which agent p would defect corresponding to the row of the element, and π₋ₚ is the respective control policies for the other agents defined by the joint control policy corresponding to the column of the element.

The system can solve the above quadratic program using the corresponding dual program, e.g., by computing one of the following:

σ*=CA^{T}α*+Cβ*+b

or

σ*=CA^{T}α*+b

where A is a matrix formed from concatenative the respective matrix Aₚ for each agent p, i.e., =[A₀, . . . , Aₚ₋₁], C=I−eb^{T},

$$b = \frac{1}{\vert {Π}^{t + 1} \vert} e ,$$

and α and β are the dual constraints.

Alternatively, the system can model the dual form using the following objective:

L_{α,β}=½(CA^{T}α+Cβ+b)^{T}(CA^{T}α+Cβ+b)−b^{T}A^{T}α−b^{T}β

In some implementations, to determine values for α* and β*, the system performs gradient ascent on respective estimates for α and β. For example, the system can determine initial estimates α₀ and β₀, e.g., α=β₀=0, and repeatedly compute:

αₜ₊₁ NN[αᵣ−γ(ACA^{T}αₜ+Ab+ϵ+ACβₜ)]

βₜ₊₁ NN[βₜ−γ(Cβₜ+b+C^{T}A^{T}αₜ)]
at multiple processing time steps t, where NN(x)=max(0,x).

Alternatively, the system can drop theft variable updates and only compute:

αₜ₊₁ NN[αₜ−γ(ACA^{T}αₜ+Ab+ϵ)]

Instead or in addition, the system can compute second order derivatives using a bounded second order linesearch optimizer. Instead or in addition, the system can incorporate a momentum parameter; precondition on the rows of the A matrix; or perform iterated elimination of strictly dominated strategies of the payoff matrix. Instead or in addition, the system can use an efficient conjugate gradient method, e.g., adapted from Polyak's algorithm.

In some implementations, the system can reduce the size of the payoff matrix and thus reduce the complexity of the computations required to solve the above formulations, e.g., using repeated action elimination or dominated action elimination.

In some implementations, the system renormalizes the L2 norm of the rows of the constraint matrix.

In some implementations, the system can determine an optimal learning rate using the eigenvalues of the Hessian of the dual form of the objective identified above. For example, the system can use the following learning rate:

$$γ = \frac{2}{{max}_{j} {\sum }_{i} \vert {D}_{ij} \vert + {min}_{j} {\sum }_{i} \vert {D}_{ij} \vert}$$

where D is the Hessian of the dual form.

In some implementations, the system can use a gap function to describe a distance from the optimum for the primal form of the objective identified above.

In some implementations, the system can directly identify a minimum value for E that produces a valid maximum Gini impurity, e.g., by optimizing over E. The system can enforce that:

$$\frac{\partial L}{\partial ϵ} \geq {e}^{T} \frac{\partial L}{\partial x} = - {e}^{T} x = - 1$$

For example, the system can add an additional objective to the dual form with a term equal to or proportional to −dϵ, where d>1.

As a particular example, the system can model the dual form using the following objective:

L_{α,β,ϵ}=−2ϵ−½α^{T}ACA^{T}α+b^{T}A^{T}α−ϵ^{T}α−½β^{T}Cβ−b^{T}β−α^{T}ACβ+½b^{T}b

After generating the mixed joint control policy at the final iteration of the system, the system can provide the mixed joint control policy to a control engine, e.g., the control engine 120 described above with reference to FIG. 1, to control the multiple agents according to the final mixed joint control policy.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers. The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method performed by one or more computers for learning a respective control policy for each of a plurality of agents interacting with an environment, the method comprising, at each of a plurality of iterations:
obtaining data specifying a current joint control policy for the plurality of agents as of the iteration, the current joint control policy specifying a respective current control policy for each of the plurality of agents; and
updating the current joint control policy by updating each of the respective current control policies for each of the plurality of agents, comprising, for each agent:
   generating a respective reward estimate for each of a plurality of alternate control policies that is an estimate of a reward received by the agent if the agent is controlled using the alternate control policy while the other agents are controlled using the respective current control policies;
   computing a best response for the agent from the respective reward estimates; and
   updating the respective current control policy for the agent using the best response for the agent.

Embodiment 2 is the method of embodiment 1, wherein, at each iteration t, updating the current joint control policy further comprises:
for each agent p, updating a set Πₚ^{t-1} that includes each previous best response for the agent p computed at previous iterations to include the best response for the current iteration, generating an updated set Πₚ^{t};
determining a combined set Π^{t}=⊗ₚΠₚ^{t}, wherein ⊗ₚ• is an outer product across elements of the sets Πᵢ^{t} for each agent i; and
updating the current joint control policy by generating a distribution σₜ across Π^{t} comprising, for each joint control policy π in Π^{t}, a likelihood that the plurality of agents execute the joint control policy π.

Embodiment 3 is the method of embodiment 2, wherein, at a first iteration:
the current joint control policy is determined to be an initial joint control policy π₀; and
the combined set is an initial combined set Π⁰={π₀}.

Embodiment 4 is the method of any one of embodiments 1-3, wherein computing the best response BRₚ^{t} for agent p at iteration t comprises computing or estimating:

$$B {R}_{p}^{t} ⊂ {arg max}_{{π}_{p}^{′} ∈ {\prod }_{p}^{*}} {\sum }_{π ∈ {\prod }^{t}} {σ}_{t} ( π ) {R}_{p} ( {π}_{p}^{′} , {π}_{- p} )$$

wherein Πₚ* is a set of all possible control policies available to agent p, Π^{t} is a set comprising all best-responses for each agent computed at previous iterations, π₋ₚ represents the respective control policy of each other agent in the plurality of agents under joint control policy π, and Rₚ(πₚ′, π₋ₚ) is the reward estimate for the agent p if the agent p executes πₚ′ and the other agents in the plurality of agents execute π₋ₚ.

Embodiment 5 is the method of any one of embodiments 1-3, wherein computing a best response for the agent p comprises computing a respective best response for the agent p for each control policy πₚ that has a non-zero likelihood under the joint control policy corresponding to the previous iteration.

Embodiment 6 is the method of embodiment 5, wherein computing the best response BRₚ^{t} for agent p at iteration t corresponding to control policy vₚ comprises computing or estimating:

$$B {R}_{p}^{t} ( {v}_{p} ) ⊂ {arg max}_{{π}_{p}^{′} ∈ {\prod }_{p}^{*}} {\sum }_{π ∈ {\prod }^{t} , {π}_{p} = {v}_{p}} {\tilde{σ}}_{t} ( π , {v}_{p} ) {R}_{p} ( {π}_{p}^{′} , {π}_{- p} )$$

$${\tilde{σ}}_{t} ( π , {v}_{p} ) = P ( π \vert {π}_{p} = {v}_{p} ) = \frac{{σ}_{t} ( π )}{{\sum }_{{π}^{′} ∈ {\prod }^{t} , {π}_{p}^{′} = {v}_{p}} {σ}_{t} ( {π}^{′} )}$$

wherein Πₚ* is a set of all possible control policies available to agent p, Π^{t} is a set comprising all best-responses for each agent computed at previous iterations, π₋ₚ represents the respective control policy of each other agent in the plurality of agents under joint control policy π, and Rₚ(πₚ′, π₋ₚ) is the reward estimate for the agent p if the agent p executes πₚ′ and the other agents in the plurality of agents execute π₋ₚ.

Embodiment 7 is the method of any one of embodiments 1-6, wherein updating the current joint control policy comprises updating the current joint control policy using a meta-solver that is configured to select a correlated equilibrium or a coarse-correlated equilibrium.

Embodiment 8 is the method of embodiment 7, wherein the meta-solver is configured to use a Gini impurity measure to select a correlated equilibrium or a coarse-correlated equilibrium.

Embodiment 9 is the method of embodiment 8, wherein the meta-solver is configured to compute the current joint control policy x* by maximizing:

$$\begin{matrix}{max}_{x} - \frac{1}{2} {x}^{T} x & s . t . \\ & {A}_{p} x \leq ϵ ∀ p \\ {x}_{i} \geq 0 ∀ i & {e}^{t} x = 1\end{matrix}$$

where Aₚ is a matrix representing a payoff gain for agent p if agent p switches its control policy, and ϵ is a hyperparameter representing error toleration.

Embodiment 10 is the method of embodiment 9, wherein the meta-solver computes the current joint control policy x* by computing one of:

x*=CA^{T}α*Cβ*+b

or

x*=CA^{T}α*+b

wherein A=[A₀, . . . , Aₚ₋₁], C=I−eb^{T},

$$b = e ,$$

e is a vector of ones, [symbol] is a set of all joint control policies across all agents, and α and β are dual constraints.

Embodiment 11 is the method of any one of embodiments 1-10, further comprising executing the control policy generated during the final iteration.

Embodiment 12 is the method of any one of embodiments 1-11 in which the reward estimate for each alternate control policy is based on rewards obtained by controlling the respective agent to perform a task by acting upon a real world environment, the controlling being performed by generating control data for the agent based on the alternate control policy.

Embodiment 13 is the method of embodiment 12 in which the agent comprises one or more of a robot or an autonomous vehicle.

Embodiment 14 is the method of any one of embodiments 12 or 13 in which the control data is obtained based on the alternate control policy and sensor data obtained from a sensor arranged to sense the real world environment.

Embodiment 15 is a method of controlling agents to perform a task in a real world environment, the method comprising:
learning a respective control policy for each of the agents by a method according to any preceding embodiment; and
generating respective control data for each of the agents based on the respective control policy and sensor data obtained from a sensor arranged to sense the real world environment; and
causing each of the agents to implement the respective control data.

Embodiment 16 is the method of embodiment 15 in which the agents comprise one or more of robots or autonomous vehicles configured to move in the real-world environment.

Embodiment 17 is a system comprising one or more computers and one or more storage devices storing instructions that when executed by the one or more computers cause the one or more computers to perform the method of any one of embodiments 1-16.

Embodiment 18 is one or more computer storage media storing instructions that when executed by one or more computers cause the one or more computers to perform the method of any one of embodiments 1-16.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers for learning a respective control policy for each of a plurality of agents interacting with an environment, the method comprising, at each of a plurality of iterations:
obtaining data specifying a current joint control policy for the plurality of agents as of the iteration, the current joint control policy specifying a respective current control policy for each of the plurality of agents; and
updating the current joint control policy by updating each of the respective current control policies for each of the plurality of agents, comprising:
for each agent:
generating a respective reward estimate for each of a plurality of alternate control policies that is an estimate of a reward received by the agent if the agent is controlled using the alternate control policy while the other agents are controlled using the respective current control policies; and
computing a best response for the agent from the respective reward estimates; and
updating the respective current control policies for the agents using the best responses for the agents.

2. The method of claim 1, wherein, at each iteration t, updating the respective current control policies comprises:
for each agent p, updating a set Πₚ^{t-1} that includes each previous best response for the agent p computed at previous iterations to include the best response for the current iteration, generating an updated set Πₚ^{t};
determining a combined set Π^{t}=⊗ₚΠₚ^{t}, wherein ⊗ₚ• is an outer product across elements of the sets Πᵢ^{t} for each agent i; and
updating the current joint control policy by generating a distribution σₜ across Π^{t} comprising, for each joint control policy π in Π^{t}, a likelihood that the plurality of agents execute the joint control policy π.

3. The method of claim 2, wherein, at a first iteration:
the current joint control policy is determined to be an initial joint control policy π₀; and
the combined set is an initial combined set Π⁰={π₀}.

4. The method of claim 1, wherein computing the best response BRₚ^{t} for agent p at iteration t comprises computing or estimating:
$$B {R}_{p}^{t} ⊂ {arg max}_{{π}_{p}^{′} ∈ {\prod }_{p}^{*}} {\sum }_{π ∈ {\prod }^{t}} {σ}_{t} ( π ) {R}_{p} ( {π}_{p}^{′} , {π}_{- p} )$$
wherein Πₚ* is a set of all possible control policies available to agent p, Π^{t} is a set comprising all best-responses for each agent computed at previous iterations, π₋ₚ represents the respective control policy of each other agent in the plurality of agents under joint control policy π, and Rₚ(πₚ′,π₋ₚ) is the reward estimate for the agent p if the agent p executes πₚ′ and the other agents in the plurality of agents execute π₋ₚ.

5. The method of claim 1, wherein computing a best response for the agent p comprises computing a respective best response for the agent p for each control policy πₚ that has a non-zero likelihood under the joint control policy corresponding to the previous iteration.

6. The method of claim 5, wherein computing the best response BRₚ^{t} for agent p at iteration t corresponding to control policy vₚ comprises computing or estimating:
$$B {R}_{p}^{t} ( {v}_{p} ) ⊂ {arg max}_{{π}_{p}^{′} ∈ {\prod }_{p}^{*}} {\sum }_{π ∈ {\prod }^{t} , {π}_{p} = {v}_{p}} {\tilde{σ}}_{t} ( π , {v}_{p} ) {R}_{p} ( {π}_{p}^{′} , {π}_{- p} )$$
$${\tilde{σ}}_{t} ( π , {v}_{p} ) = P ( π \vert {π}_{p} = {v}_{p} ) = \frac{{σ}_{t} ( π )}{{\sum }_{{π}^{′} ∈ {\prod }^{t} , {π}_{p}^{′} = {v}_{p}} {σ}_{t} ( {π}^{′} )}$$
wherein Πₚ* is a set of all possible control policies available to agent p, Π^{t} is a set comprising all best-responses for each agent computed at previous iterations, π₋ₚ represents the respective control policy of each other agent in the plurality of agents under joint control policy π, and Rₚ(πₚ′,π₋ₚ) is the reward estimate for the agent p if the agent p executes πₚ′ and the other agents in the plurality of agents execute π₋ₚ.

7. The method of claim 1, wherein updating the current joint control policy comprises updating the current joint control policy using a meta-solver that is configured to select a correlated equilibrium or a coarse-correlated equilibrium.

8. The method of claim 7, wherein the meta-solver is configured to use a Gini impurity measure to select a correlated equilibrium or a coarse-correlated equilibrium.

9. The method of claim 8, wherein the meta-solver is configured to compute the current joint control policy x* by maximizing:
$$\begin{matrix}{max}_{x} - \frac{1}{2} {x}^{T} x & s . t . \\ & {A}_{p} x \leq ϵ ∀ p \\ {x}_{i} \geq 0 ∀ i & {e}^{t} x = 1\end{matrix}$$
where Aₚ is a matrix representing a payoff gain for agent p if agent p switches its control policy, and ϵ is a hyperparameter representing error toleration.

10. The method of claim 9, wherein the meta-solver computes the current joint control policy x* by computing one of:
x*=CA^{T}α*+Cβ*+b
or
x*=CA^{T}α*+b
wherein A=[A₀, . . . , Aₚ₋₁], C=1−eb^{T},
$$b = e ,$$
e is a vector of ones, [symbol] is a set of all joint control policies across all agents, and α and β are dual constraints.

11. The method of claim 1, further comprising executing the control policy generated during the final iteration.

12. The method of claim 1 in which the reward estimate for each alternate control policy is based on rewards obtained by controlling the respective agent to perform a task by acting upon a real world environment, the controlling being performed by generating control data for the agent based on the alternate control policy.

13-17. (canceled)

18. One or more non-transitory computer-readable storage media storing instructions that when executed by one or more computers cause the one or more computers to perform operations for learning a respective control policy for each of a plurality of agents interacting with an environment, the operations comprising, at each of a plurality of iterations:
obtaining data specifying a current joint control policy for the plurality of agents as of the iteration, the current joint control policy specifying a respective current control policy for each of the plurality of agents; and
updating the current joint control policy by updating each of the respective current control policies for each of the plurality of agents, comprising:
for each agent:
generating a respective reward estimate for each of a plurality of alternate control policies that is an estimate of a reward received by the agent if the agent is controlled using the alternate control policy while the other agents are controlled using the respective current control policies; and
computing a best response for the agent from the respective reward estimates; and
updating the respective current control policies for the agents using the best responses for the agents.

19. A system comprising one or more computers and one or more storage devices storing instructions that when executed by the one or more computers cause the one or more computers to perform operations for learning a respective control policy for each of a plurality of agents interacting with an environment, the operations comprising, at each of a plurality of iterations:
obtaining data specifying a current joint control policy for the plurality of agents as of the iteration, the current joint control policy specifying a respective current control policy for each of the plurality of agents; and
updating the current joint control policy by updating each of the respective current control policies for each of the plurality of agents, comprising:
for each agent:
generating a respective reward estimate for each of a plurality of alternate control policies that is an estimate of a reward received by the agent if the agent is controlled using the alternate control policy while the other agents are controlled using the respective current control policies; and
computing a best response for the agent from the respective reward estimates; and
updating the respective current control policies for the agents using the best responses for the agents.

20. The system of claim 19, wherein, at each iteration t, updating the respective current control policies comprises:
for each agent p, updating a set Πₚ^{t-1} that includes each previous best response for the agent p computed at previous iterations to include the best response for the current iteration, generating an updated set Πₚ^{t};
determining a combined set Π^{t}=⊗ₚΠₚ^{t}, wherein ⊗ₚ• is an outer product across elements of the sets n for each agent i; and
updating the current joint control policy by generating a distribution σₜ across Π^{t} comprising, for each joint control policy π in Π^{t}, a likelihood that the plurality of agents execute the joint control policy π.

21. The system of claim 20, wherein, at a first iteration:
the current joint control policy is determined to be an initial joint control policy π₀; and
the combined set is an initial combined set Π⁰={π₀}.

22. The system of claim 21 wherein computing the best response BRₚ^{t} for agent p at iteration t comprises computing or estimating:
$$B {R}_{p}^{t} ⊂ {arg max}_{{π}_{p}^{′} ∈ {\prod }_{p}^{*}} {\sum }_{π ∈ {\prod }^{t}} {σ}_{t} ( π ) {R}_{p} ( {π}_{p}^{′} , {π}_{- p} )$$
wherein πₚ* is a set of all possible control policies available to agent p, Π^{t} is a set comprising all best-responses for each agent computed at previous iterations, π₋ₚ represents the respective control policy of each other agent in the plurality of agents under joint control policy π, and Rₚ(πₚ′,π₋ₚ) is the reward estimate for the agent p if the agent p executes πₚ′ and the other agents in the plurality of agents execute π₋ₚ.

23. The system of claim 19, wherein computing a best response for the agent p comprises computing a respective best response for the agent p for each control policy πₚ that has a non-zero likelihood under the joint control policy corresponding to the previous iteration.

24. The system of claim 23, wherein computing the best response BRₚ^{t} for agent p at iteration t corresponding to control policy vₚ comprises computing or estimating:
$$B {R}_{p}^{t} ( {v}_{p} ) ⊂ {arg max}_{{π}_{p}^{′} ∈ {\prod }_{p}^{*}} {\sum }_{π ∈ {\prod }^{t} , {π}_{p} = {v}_{p}} {\tilde{σ}}_{t} ( π , {v}_{p} ) {R}_{p} ( {π}_{p}^{′} , {π}_{- p} )$$
$${\tilde{σ}}_{t} ( π , {v}_{p} ) = P ( π \vert {π}_{p} = {v}_{p} ) = \frac{{σ}_{t} ( π )}{{\sum }_{{π}^{′} ∈ {\prod }^{t} , {π}_{p}^{′} = {v}_{p}} {σ}_{t} ( {π}^{′} )}$$
wherein Πₚ* is a set of all possible control policies available to agent p, Π^{t} is a set comprising all best-responses for each agent computed at previous iterations, π₋ₚ represents the respective control policy of each other agent in the plurality of agents under joint control policy and Rₚ(πₚ′,π₋ₚ) is the reward estimate for the agent p if the agent p executes πₚ′ and the other agents in the plurality of agents execute π₋ₚ.

25. The system of claim 19, wherein updating the current joint control policy comprises updating the current joint control policy using a meta-solver that is configured to select a correlated equilibrium or a coarse-correlated equilibrium.
